(19) United States
(12) Patent Application Publication
(10) Pub. No.: US 2026/0149284 A1
(43) Pub. Date: May 28, 2026

(54) METHOD AND APPARATUS FOR OPTIMAL CONTROL OF POWER GRID BY USING DIGITAL TWIN

(71) Applicant: Korea Electronics Technology Institute, Seongnam-si (KR)

(72) Inventors: Sang Yub LEE, Yongin-si (KR); In Pyo CHO, Yongin-si (KR); Jae Kyu LEE, Yongin-si (KR); Sung Min LIM, Guri-si (KR)

(21) Appl. No.: 19/077,594

(22) Filed: Mar. 12, 2025

(30) Foreign Application Priority Data
Nov. 26, 2024 (KR) 10-2024-0171098

(51) Int. Cl. H02J 3/38; G05B 13/04; H02J 3/00

(52) U.S. Cl. CPC H02J 3/38; G05B 13/048; H02J 3/003; H02J 3/004; H02J 2103/30

(57) ABSTRACT

A method for optimal control of a power grid is proposed. The method may include generating, by using a processor, a digital twin model which learns synthetic data and collected data respectively obtained in a power generation resource unit and a demand resource unit to predict grid balancing. The method may also include correcting power grid data of an open platform by using a power grid data prediction model executed by the processor, based on an error between the power grid data obtained in the open platform and power grid data obtained in a real time simulator (RTS). The method may further include controlling the power generation resource unit and the demand resource unit by using a control module executed by the processor, based on grid balancing data predicted by the digital twin model and the corrected power grid data of the open platform.

### CROSS-REFERENCE TO RELATED APPLICATIONS

This application claims the benefit of Korean Patent Application No. 10-2024-0171098 filed on Nov. 26, 2024, which is hereby incorporated by reference in its entirety.

### BACKGROUND

The present disclosure relates to a method and apparatus for optimal control of a power grid, and more particularly, to a method and apparatus for optimal control of a power grid by using a digital twin.

### SUMMARY

One aspect is a method and an apparatus, which may generate a digital twin model for increasing the accuracy of prediction of grid balancing by using generated data (synthetic data or virtual data) along with collected data (sensing data) obtained through various sensors and may optimally control a power grid by using the digital twin model.

Another aspect is a method for optimal control of a power grid, the method including: a step of generating, by using a processor, a digital twin model which learns synthetic data and collected data respectively obtained in a power generation resource unit and a demand resource unit to predict grid balancing; a step of correcting power grid data of an open platform by using a power grid data prediction model executed by the processor, based on an error between the power grid data obtained in the open platform and power grid data obtained in a real time simulator (RTS); and a step of controlling the power generation resource unit and the demand resource unit by using a control module executed by the processor, based on grid balancing data predicted by the digital twin model and the corrected power grid data of the open platform.

Another aspect is an apparatus for optimal control of a power grid, the apparatus including: a communication device; a data collection device configured to respectively collect synthetic data and collected data from a power generation resource unit and a demand resource unit through the communication device; and a processor configured to generate a digital twin model which learns the collected synthetic data and collected data to predict grid balancing, wherein the processor corrects power grid data based on the open platform, based on an error between the power grid data obtained in the open platform and power grid data obtained in a real time simulator (RTS) and generates a control signal controlling a power generation resource unit and a demand resource unit by using the corrected power grid data of the open platform and grid balancing data predicted by the digital twin model.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure.

FIG. 1 is a conceptual diagram of a general digital twin.

FIG. 2 is a conceptual diagram for describing a system configuration according to an embodiment of the present disclosure.

FIG. 3 is a block diagram of an apparatus for optimal control of a power grid according to an embodiment of the present disclosure.

FIG. 4 is a diagram for describing data fusion performed in a hybrid model of FIG. 3.

FIG. 5 is a diagram for describing a process of correcting power grid data of an open platform performed by a data corrector of FIG. 3.

FIG. 6 is a flowchart illustrating a method for optical control of a power grid according to an embodiment of the present disclosure.

FIG. 7 is an exemplary configuration diagram of a computing device for performing the method of FIG. 6.

### DETAILED DESCRIPTION

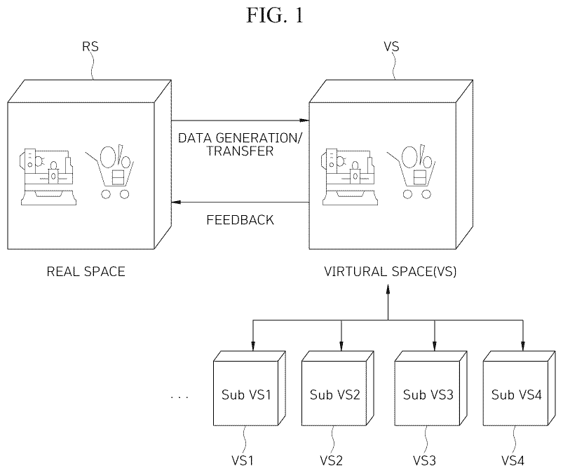

FIG. 1 is a conceptual diagram of a general digital twin. Referring to FIG. 1, the digital twin includes a real space RS, a virtual space VS, a connection between the real space RS and the virtual space VS, and a mutual connection between the virtual space VS and sub virtual spaces VS1 to VS4 and denotes a concept which provides a desired service and optimizes performance, based on the elements. In this case, the real space RS is not limited to only shown equipment and may include various components such as collected data, a performed process, and software. Also, the digital twin should be configured to be suitable for the purpose thereof. For example, in a case where a factory is configured with a digital twin, a desired parameter, an input/output, and a control value may be changed based on the purpose thereof, namely, whether the digital twin is a digital twin for a manufacturing process or whether the digital twin is a digital twin for energy saving.

Furthermore, a conventional digital twin for energy saving generates a data model corresponding to collected data (sensing data) obtained from various sensors and predicts grid balancing between the amount of power generation (the amount of power production) and the amount of consumption (the amount of power consumption) needed for a current power grid. In this case, because depending on the collected data (sensing data), in an environment where it is difficult to collect data or a case where abnormal data is collected, the accuracy of prediction of grid balancing is reduced, and due to this, the optical control of a power grid is difficult.

Reference will now be made in detail to the exemplary embodiments of the present disclosure, examples of which are illustrated in the accompanying drawings. Wherever possible, the same reference numbers will be used throughout the drawings to refer to the same or like parts.

In the following description, the technical terms are used only for explaining a specific embodiment while not limiting the present disclosure. The terms of a singular form may include plural forms unless referred to the contrary. The meaning of ‘comprise’, ‘include’, or ‘have’ specifies a property, a region, a fixed number, a step, a process, an element and/or a component but does not exclude other properties, regions, fixed numbers, steps, processes, elements and/or components.

In the present disclosure, in addition to visualizing simply collected data, the reliability of power grid information may increase by collecting the power grid information in real time, based on technology for accurate prediction of the amount of power generation associated with meteorological information for optimal control and operation, and the power grid information may be used as learning data needed for control. Particularly, a frame network implementing a control algorithm based on a power grid situation in a digital twin may be proposed by controlling a time scale of power grid information (hour unit) and power generation amount/demand amount prediction information (minute unit).

In conventional technology, a current state has been three-dimensionally visualized based on collected data, and thus, an operation and control logic has been developed. On the other hand, the present disclosure may propose to develop the operation and control logic in real time by using power grid information and power generation amount/demand amount prediction information.

Moreover, the conventional technology has provided a digital twin platform which displays in a system by using collected data (sensor data), and in a case which uses only the collected data (sensor data), when the omission of data occurs, or the amount of collected data is small, it is difficult to develop a data model. On the other hand, the present disclosure may provide a software framework which may implement an optimal operation and control logic suitable for a current grid state by using power grid information and power generation amount/demand amount prediction information.

Moreover, the present disclosure may propose a method which may control an obtainment level of power grid information to match a time scale between a simple result (minute unit) and a detailed result (hour unit), in a case which obtains the power grid information. The simple result may represent a power flow analysis result, and the detailed result may include internal voltage and current information as well as power flow analysis and may provide thoughtful analysis. The present disclosure may propose a system which may map various analysis results to power generation amount/demand amount prediction (for example, a minute unit) to obtain an operation and control result in real time (for example, a minute unit).

Moreover, in terms of power generation amount and demand amount prediction, the present disclosure may propose a method which may propose a method which may enhance the degree of accuracy by using physical model-based generated data (synthetic data or virtual data) of a corresponding power generation resource (sunlight, wind power, and energy storage device) in a case which data is omitted or the amount of collected data is small, so as to increase the accuracy of prediction in a conventional method of simply using collected data.

Moreover, the present disclosure may propose a method which may control time scales of various information and may combine results of the control so as to construct a digital twin system, and thus, may provide a framework which may collect and generate data needed for optimal operation and control.

Moreover, in the related art, because a simulation time of an hour unit is needed for verifying and checking power grid information, it is difficult to apply power grid state update information to a minute unit control model. Om the other hand, the present disclosure may provide a method which may control a result difference between ‘power grid information open platform’ providing minute-unit data and ‘power grid information real time simulator (RTS)’providing hour-unit data and may reflect a control result in a control module.

Hereinafter, embodiments of the present disclosure will be described in detail with reference to the accompanying drawings.

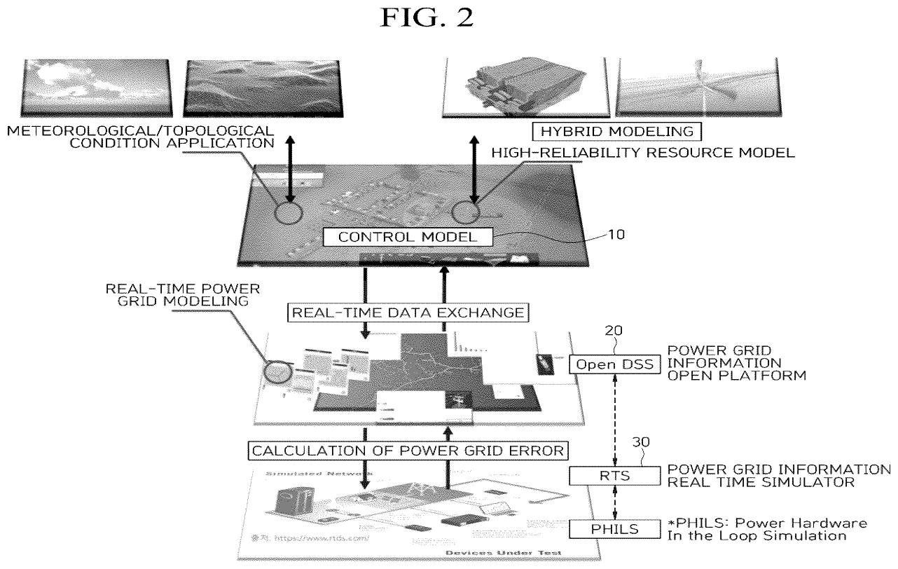

FIG. 2 is a conceptual diagram for describing a system configuration according to an embodiment of the present disclosure.

Referring to FIG. 2, data transferred to a control module 10 may include meteorological/topographical data, data associated with a power generation resource and a demand resource through hybrid modeling, power grid data of a power grid information open platform 20, and power grid data of a power grid information real time simulator (RTS) 30.

The power grid information open platform 20 may be a software platform (a software application) which simulates a power grid state to calculate schematic grid data such as power flow analysis, an active power, and a reactive power in real time (for example, minute unit).

The power grid information RTS 30 may be a simulator which simulates detailed power grid data including a current, a voltage, and frequency information as well as an active power, a reactive power, and accurate power flow analysis between a power grid state and a power grid connection point.

The RTS 30 may calculate accurate power grid data, based on a constructed power grid, but may have a problem where a simulation analysis time of ten minutes to several hours is consumed. Also, when a change in resource situation occurs in a simulation driving time, there may be a limitation where it is unable to calculate a real-time result thereof.

The present disclosure may apply a module which calculates an error between accurate data of the RTS 30 and data provided by the power grid information open platform 20 based on open distribution system simulator (DSS). Subsequently, the control module 10 may reflect a continuous error to gather data and may be used in a control logic, based on gathered content.

Hereinafter, a system configuration according to an embodiment of the present disclosure will be described in more detail.

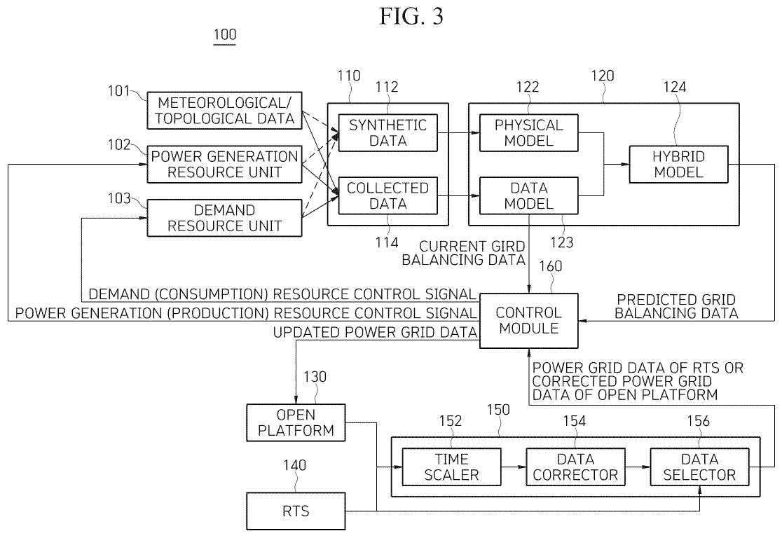

FIG. 3 is a block diagram of an apparatus 100 for optimal control of a power grid according to an embodiment of the present disclosure.

Referring to FIG. 3, the apparatus 100 for optimal control of a power grid according to an embodiment of the present disclosure may include a data collection unit (or a data collection processor) 110, a digital twin model 120, an open platform 130, an RTS 140, and a power grid data prediction model 150, and a control module (or a controller or processor) 160.

The data collection unit 110 may collect synthetic data and collected data.

The synthetic data may include virtual meteorological/topographical data, virtual power generation amount data (virtual power generation data) provided from the distributed power generation resource unit 102, and virtual demand amount data (virtual power consumption data) provided from a demand resource unit 103.

The collected data may include real meteorological/topographical data, real power generation amount data (real power generation data) provided from the distributed power generation resource unit 102, and real demand amount data (real power consumption data) provided from a demand resource unit 103.

The virtual meteorological/topographical data may be collected from weather modeling software, weather simulation tool, artificial intelligence and machine running, topographical modeling software, and digital elevation model, which operate in an external server (not shown). In FIG. 3, the virtual meteorological/topographical data is illustrated by a dotted-line arrow. The real meteorological/topographical data may be obtained from Meteorological Administration, Environment Agency, Satellite Data Providing Organization, and national weather database. In FIG. 3, the real meteorological/topographical data is illustrated by a solid-line arrow.

The power generation resource unit 102 may include, for example, a solar photovoltaic power station, a wind power plant, a thermoelectric power plant, a nuclear power plant, a water power plant, and an energy storage system (ESS). The virtual power generation amount data (virtual power generation data) provided from the power generation resource unit 102 may be obtained from computational fluid dynamics (CFD) which numerically simulates a flow of fluid, heat transfer, and a chemical reaction and computer-aided engineering (CAE) which evaluates the design and performance of a power generation system and simulates various operating conditions. In FIG. 3, the virtual power generation amount data (virtual power generation data) is illustrated by a dotted-line arrow. The real power generation amount data (real power generation data) may be obtained directly from a smart meter, a power analyzer, an energy monitoring system, and various sensors, which are installed in a power generation plant. In FIG. 3, the real power generation amount data (real power generation data) is illustrated by a solid-line arrow.

The demand resource unit 103 may include, for example, a smart meter, a power analyzer, and an energy monitoring system, which are installed in a building, a campus, or the like. The virtual demand amount data (virtual power consumption data) provided from the demand resource unit 103 may be obtained from machine learning, artificial intelligence, and simulation software such as EnergyPlus or TRNSYS. In FIG. 3, the virtual demand amount data (virtual power consumption data) is illustrated by a dotted-line arrow. The real demand amount data (real power consumption data) may be obtained directly from a smart meter, a power analyzer, and an energy monitoring system, which are installed in a building, a campus, or the like. In FIG. 3, the real demand amount data (real power consumption data) is illustrated by a solid-line arrow.

The digital twin model 120 may be a model which learns the synthetic data and the collected data to predict grid balancing. The digital twin model 120 may include a physical model 122, a data model 123, and a hybrid model 124.

The physical model 122 may be a model which is trained to predict grid balancing (hereinafter referred to as first grid balancing data) by using synthetic data 112 as learning data. That is, the physical model 122 may be a model which is generated by using virtual data (virtual meteorological/topographical data, virtual power generation amount data, and virtual demand amount data) as learning data. In another viewpoint, the physical model 122 may predict a power generation resource and a demand resource, based on a physical law and equation corresponding to a power generation resource and a demand resource, and may predict grid balancing therebetween.

The data model 123 may be a model which is generated to predict grid balancing (hereinafter referred to as second grid balancing data) by using collected data 114 as learning data. That is, the data model 123 may be a model which is generated by using real data (real meteorological/topographical data, real power generation amount data, and real demand amount data) as learning data. In another viewpoint, the data model 123 may learn a pattern to predict a power generation resource and a demand resource, based on past data which is actually collected, and may predict grid balancing therebetween.

The hybrid model 124 may be a model which is trained to predict final grid balancing data by using learning data including the synthetic data 112, the collected data 114, the first grid balancing data, and the second grid balancing data. That is, the hybrid model 124 may fuse the synthetic data 112, the collected data 114, the first grid balancing data, and the second grid balancing data to predict the final grid balancing data.

In the present disclosure, the grid balancing data may be data for balancing the amount of power generation (the amount of power production) and the amount of power demand (the amount of power consumption) of a power grid. Predicted grid balancing data may include, for example, future power generation amount data (future power production amount data) which is predicted to maintain balancing between the amount of past power demand and the amount of current power demand (the amount of power consumption), based on a meteorological/topographical condition, and future power demand amount data (future power consumption amount data) which is predicted to maintain balancing between the amount of past power generation and the amount of current power generation (the amount of power production), based on the meteorological/topographical condition.

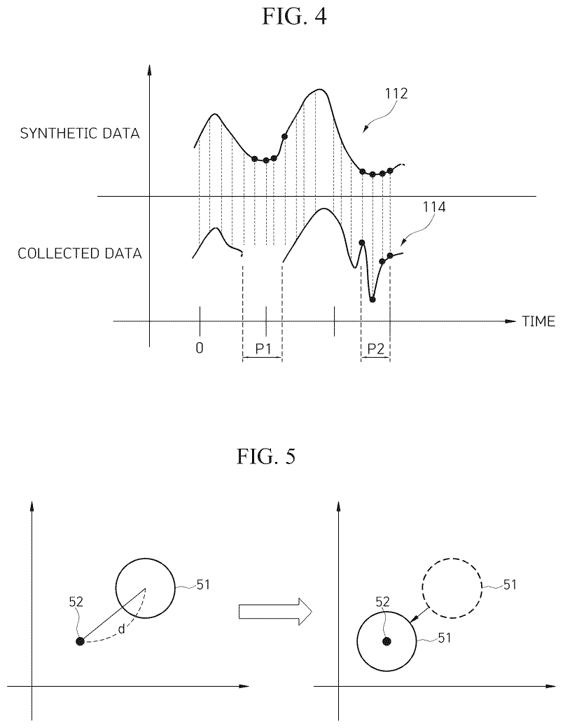

FIG. 4 is a diagram for describing data fusion performed in a hybrid model of FIG. 3.

Referring to FIG. 4, as described above, the hybrid model 124 may perform learning to fuse the synthetic data 112, the collected data 114, the first grid balancing data, and the second grid balancing data to predict the final grid balancing data.

For example, when the collected data 114 is omitted in a specific time period, the hybrid model 124 may learn synthetic data corresponding to the specific time period. Also, when a difference value between a variation rate of the synthetic data 112 and a variation rate of the collected data 114 is outside a predetermined error range in the specific time period, the hybrid model 124 may learn the collected data 114 corresponding to the specific time period. This may be because the reliability of the collected data 114 which is real data is higher than that of the synthetic data 112 which is meteorological data.

In detail, when the collected data 114 is omitted in a first time period P1, the hybrid model 124 may learn the synthetic data 112 which is obtained in the first time period P1, and when a difference value between a variation rate of the synthetic data 112 and a variation rate of the collected data 114 is outside the predetermined error range in a second time period P2, the hybrid model 124 may learn the collected data 114 which is obtained in the second time period P2.

As described above, when collected data is insufficient or is omitted, the hybrid model 124 may use synthetic data, and when a difference value between a variation rate of the synthetic data and a variation rate of the collected data is outside the error range, the hybrid model 124 may fuse the synthetic data and the collected data by using the collected data which is higher in reliability and may perform learning to predict grid balancing, based on fused data. Accordingly, the hybrid model 124 may more accurately predict grid balancing.

Referring again to FIG. 3, the control module 160 may perform optimal control on a power grid including the power generation resource unit 102 and the demand resource unit 103, based on grid balancing data predicted by the digital twin model 120. At this time, the control module 160 may perform more precise optimal control on a power grid by further using power grid data obtained by the open platform 130 and power grid data obtained by the RTS 140.

The open platform 130 may be a software platform (a software application) which simulates a power grid state to analyze schematic power grid data including power flow analysis, an active power, and a reactive power in real time (for example, minute unit), and for example, may be an open DSS.

The RTS 140 may simulate detailed power grid data including a current, a voltage, and frequency information as well as an active power, a reactive power, and accurate power flow analysis between a power grid state and a connection point or an access point of a power grid.

The RTS 140 may provide high-resolution information between resources, but may have a problem where a simulation time is long and power grid data is not provided by minute units like the open platform 130.

To solve the problem of the RTS 140, the present disclosure may correct power grid data of the open platform 130, based on an error between power grid data obtained in the open platform 130 and power grid data obtained in the RTS 140, and may use the corrected power grid data of the open platform 130 as data for performing optimal control on a power grid. The correction of the power grid data of the open platform 130 may be performed by the power grid data prediction model 150.

The power grid data prediction model 150 may include a time scaler 152 and a data corrector 154.

The time scaler 152 may synchronize a time resolution of the open platform 130 with a time resolution of the RTS 140. For example, the time scaler 152 may adjust the time resolution of the RTS 140, based on the time resolution of the open platform 130. Such a process may be a process of sampling and extracting power grid data obtained by the RTS 140 as the time resolution of the open platform 130. Based on such time synchronization, data consistency between power grid data of the open platform 130 and power grid data of the RTS 140 may be maintained.

The data corrector 154 may calculate an error between the power grid data of the open platform 130 and the power grid data of the RTS 140 where the time resolution has been adjusted and may correct the power grid data of the open platform 130, based on the calculated error.

FIG. 5 is a diagram for describing a process of correcting power grid data of an open platform performed by the data corrector of FIG. 3.

Referring to FIG. 5, in order to correct power grid data of the open platform 130, first, the data corrector 154 may cluster the power grid data of the open platform 130 to generate a cluster. Here, for example, k-mean clustering may be used as a clustering method. Subsequently, the data corrector 154 may represent the cluster as a circle 51 and may represent the power grid data of the RTS 140 as a point 52 in a two-dimensional coordinate system, and then, when the point 52 is outside the circle 51, the data corrector 154 may calculate a distance value d between coordinates of the point 52 and center coordinates of the circle 51 as an error between the power grid data of the open platform 130 and the power grid data of the RTS 140. Subsequently, the data corrector 154 may adjust the distance value d to move the circle 51 so that the circle 51 includes the point 52, and thus, may correct the power grid data of the open platform 130.

The correction of the power grid data of the open platform 130 may complement schematic power grid data of the open platform 130, based on precise power grid data of the RTS 140, and thus, when the corrected power grid data of the open platform 130 is used, the control module 160 may more precisely control a power generation resource and a demand resource of a power grid.

Referring again to FIG. 3, the power grid data prediction model 150 may further include a data selector 156. The data selector 156 may select one piece of power grid data from among the power grid data of the RTS 140 and the power grid data of the open platform 130 corrected by the data corrector 154 and may transfer the selected power grid data to the control module 160.

For example, in a case (a case where the point 52 is outside the circle 51 in FIG. 5) where an error d between the power grid data of the open platform 130 and the power grid data of the RTS 140 is greater than or equal to a threshold value (a radius of the circle 51 in FIG. 5), the data selector 156 may correct the power grid data of the open platform 130, based on the calculated error, and may then select the power grid data of the open platform 130 to transfer the selected power grid data to the control module 160, and in a case (a case where the point 52 is in the circle 51 in FIG. 5) where the error d is less than the threshold value, the data selector 156 may select the power grid data of the RTS 140 to transfer the selected power grid data to the control module 160. At this time, in a case where the error d is less than the threshold value, the data corrector 154 may not perform a correction operation on the power grid data of the open platform 130. The case where the error d is less than the threshold value may denote that a reliability difference between the power grid data of the open platform 130 and the power grid data of the RTS 140 is not large. In this case, it may be preferable to use the power grid data of the RTS 140 representing a more precise power grid state.

In an embodiment, the control module 160 may generate a control signal for controlling the power generation resource unit 102 and the demand resource unit 103 by using the predicted grid balancing data transferred from the digital twin model 120 and the corrected power grid data of the open platform transferred from the power grid data prediction model 150.

In another embodiment, the control module 160 may generate a control signal for controlling the power generation resource unit 102 and the demand resource unit 103 by using the predicted grid balancing data transferred from the digital twin model 120 and the power grid data of the RTS transferred from the power grid data prediction model 150.

In another embodiment, the control module 160 may generate a control signal for controlling the power generation resource unit 102 and the demand resource unit 103 by using the predicted grid balancing data transferred from the digital twin model 120, the current grid balancing data transferred from the data model 123 included in the digital twin model 120, and the corrected power grid data of the open platform transferred from the power grid data prediction model 150.

A control signal generated by the control module 160 may be a signal which controls charging or discharging of each of the power generation resource unit 102 and the demand resource unit 103.

In another embodiment, the control module 160 may further generate updated power grid data, and the open platform 130 may be updated by the updated power grid data.

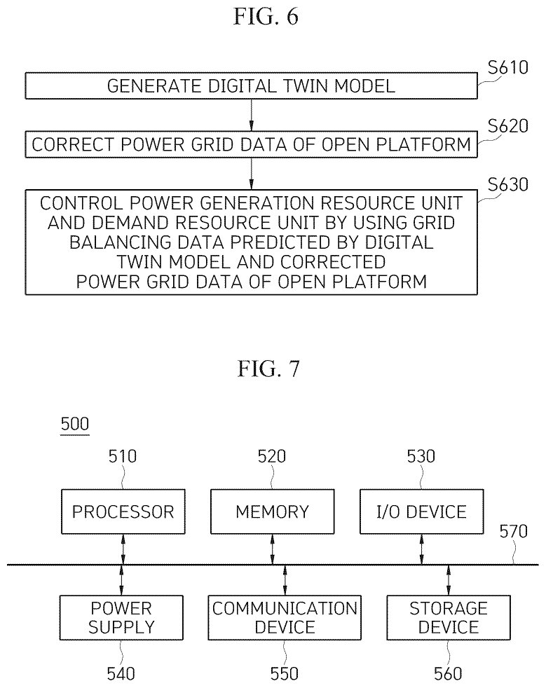

FIG. 6 is a flowchart illustrating a method for optical control of a power grid according to an embodiment of the present disclosure.

Referring to FIG. 6, first, in step S610, a step of generating a digital twin model which learns synthetic data and collected data respectively obtained in a power generation resource unit and a demand resource unit to predict grid balancing may be performed.

Subsequently, in step S620, a step of correcting power grid data of an open platform by using a power grid data prediction model, based on an error between the power grid data obtained in the open platform and power grid data obtained in an RTS, may be performed.

Subsequently, in step S630, a step of controlling the power generation resource unit and the demand resource unit by using a control module, based on grid balancing data predicted by the digital twin model and the corrected power grid data of the open platform, may be performed.

In an embodiment, the step S610 of generating the digital twin model may include a step of generating a physical model which learns the synthetic data to predict first grid balancing data for balancing the amount of prediction power generation and the amount of prediction demand, a step of generating a data model which learns the collected data to predict second grid balancing data for balancing the amount of prediction power generation and the amount of prediction demand, a step of generating a hybrid model which learns the synthetic data, the collected data, the first grid balancing data, and the second grid balancing data to predict the grid balancing data, and a step of connecting an output of each of the physical model and the data model to an input of the hybrid model.

In an embodiment, the step of generating the hybrid model may include a step of learning the synthetic data obtained in a first time period when the collected data is omitted in the first time period, a step of learning the synthetic data obtained in the first time period, and a step of learning the collected data obtained in a second time period when a difference value between a variation rate of the synthetic data and a variation rate of the collected data is outside a predetermined error range in the second time period.

In an embodiment, the step S620 of correcting the power grid data based on the open platform may include a step of adjusting a time resolution of the RTS with respect to a time resolution of the open platform by using the time scaler 152 and a step of calculating an error between the power grid data of the open platform and the power grid data of the RTS having the adjusted time resolution and correcting the power grid data of the open platform by using the data corrector 154, based on the calculated error.

In an embodiment, the step of correcting the power grid data of the open platform based on the calculated error may include a step of clustering the power grid data of the open platform to generate a cluster, a step of representing the cluster as a circle in a two-dimensional coordinate system, a step of representing the power grid data of the RTS as a point, a step of calculating a distance value between coordinates of the point and center coordinates of the circle as the error when the point is outside the circle, and a step of adjusting the distance value to move the circle so that the circle includes the point 52, thereby correcting the power grid data of the open platform.

In an embodiment, a step of, when the error is greater than or equal to a predetermined threshold value, correcting the power grid data of the open platform by using the data selector 156, based on the calculated error, and then, inputting the corrected power grid data of the open platform to the control module, and a step of inputting the power grid data of the RTS to the control module when the error is less than the threshold value may be further performed.

FIG. 7 is an exemplary configuration diagram of a computing device 500 for performing the method of FIG. 6.

Referring to FIG. 7, the computing device 500 may be a main element which performs each step in the method of FIG. 6. To this end, the computing device 500 may include a processor 510, a memory 520, an input/output (I/O) device 530, a power supply 540, a communication device 550, a storage device 560, and a system bus 570 connecting the elements 510 to 560 with each other.

The processor 510 may be a main element which performs each step in the method of FIG. 6, or may be an element which executes the main element. The processor 510 may be an element which performs a core function of the computing device 500 and may interpret and execute an assigned instruction.

The memory 520 may be a device which temporarily stores desired data in a case where the processor 510 processes an operation. The memory 520 may include a volatile memory and/or a non-volatile memory.

The I/O device 530 may function as an interface with a user or an external system. The input device may include, for example, a keyboard and a touch screen. The output device may include a speaker and a display device.

The power supply 540 may be a device which supplied power to the computing device 500.

The communication device (or a communication interface) 550 may transmit or receive data through a connection with an external network. The communication device 550 may support wireless/wired communication so that the computing device 500 communicates with power generation resource unit 102 and the demand resource unit 103. Here, the wireless communication may include short-range wireless communication, mobile communication (for example, 3G, 4G, LTE, 5G, 6G, etc.), wireless Internet communication, and satellite communication.

The storage device 560 may be a device which is used to store data for a long time and may be a device which stores intermediate data and/or result data generated in each step in the method of FIG. 6. Also, the storage device 560 may store various software algorithms for performing each step in the method of FIG. 6 and an operating system program where the software algorithm is executed. The storage device 560 may store the synthetic data 112, the collected data 114, and the digital twin model 120, the power grid data prediction model 150, and the control module 160, which are generated by the processor 510.

The system bus 570 may be a communication path which connects all elements, such as the processor 510, the memory 520, the I/O device 530, and the communication device 550, with one another.

According to the present disclosure, in maintaining and operating of a microgrid or a grid-connected system, various resources such as consumption resources and distributed resources (power generation resources) and an ESS may be controlled by using error calculation of grid data and hybrid modeling for operation and control optimization, and appropriate grid information may be updated in real time for various energy exchanges (sector coupling) between consumption resources and distributed resources, and thus, grid balancing may be optimized.

Moreover, the present disclosure may solve a time difference between a result of a grid analysis simulation and real-time grid data in which the result is reflected and may provide a solution capable of responding to real-time power trade market (minute unit). Accordingly, a digital twin model based on an artificial intelligence model capable of being accurately visualized in real time may be designed.

Moreover, a provider constructing a new power grid may simulate an accurate prediction value, based on the form of power grid (solar energy generation, wind power generation, energy storage devices, fuel cells, etc.) which is operated in the future, and thus, may analyze economical efficiency.

Moreover, results of the present disclosure may be used as a consulting material which may accurately determine whether installation is possible on additionally installed power generation resources and demand (consumption) resources in connection with real-time grid information (minute unit), or whether another resource is not affected thereby.

In response to natural disasters and sudden accidents, various scenarios may be designed, and various resources may be optimally controlled to be suitable for a grid situation.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for optimal control of a power grid, the method comprising:
generating, by using a processor, a digital twin model which learns synthetic data and collected data respectively obtained in a power generation resource unit and a demand resource unit to predict grid balancing;
correcting power grid data of an open platform by using a power grid data prediction model executed by the processor, based on an error between the power grid data obtained in the open platform and power grid data obtained in a real time simulator (RTS); and
controlling the power generation resource unit and the demand resource unit by using a control module executed by the processor, based on grid balancing data predicted by the digital twin model and the corrected power grid data of the open platform.

2. The method of claim 1, wherein generating the digital twin model comprises:
generating a physical model which learns the synthetic data to predict first grid balancing data for balancing the amount of prediction power generation and the amount of prediction demand;
generating a data model which learns the collected data to predict second grid balancing data for balancing the amount of prediction power generation and the amount of prediction demand;
generating a hybrid model which learns the synthetic data, the collected data, the first grid balancing data, and the second grid balancing data to predict the grid balancing data; and
connecting an output of each of the physical model and the data model to an input of the hybrid model.

3. The method of claim 2, wherein generating the hybrid model comprises:
learning the synthetic data obtained in a first time period when the collected data is omitted in the first time period; and
learning the collected data obtained in a second time period when a difference value between a variation rate of the synthetic data and a variation rate of the collected data is outside a predetermined error range in the second time period.

4. The method of claim 1, wherein correcting the power grid data based on the open platform comprises:
adjusting a time resolution of the RTS with respect to a time resolution of the open platform by using a time scaler; and
calculating an error between the power grid data of the open platform and the power grid data of the RTS having the adjusted time resolution and correcting the power grid data of the open platform by using a data corrector, based on the calculated error.

5. The method of claim 4, wherein correcting the power grid data of the open platform based on the calculated error comprises:
clustering the power grid data of the open platform to generate a cluster;
representing the cluster as a circle and representing the power grid data of the RTS as a point in a two-dimensional coordinate system;
calculating a distance value between coordinates of the point and center coordinates of the circle as the error when the point is outside the circle; and
adjusting the distance value to move the circle so that the circle includes the point, thereby correcting the power grid data of the open platform.

6. The method of claim 4, further comprising:
when the error is greater than or equal to a predetermined threshold value, correcting the power grid data of the open platform, based on the calculated error, and inputting the corrected power grid data of the open platform to the control module; and
inputting the power grid data of the RTS to the control module when the error is less than the predetermined threshold value.

7. An apparatus for optimal control of a power grid, the apparatus comprising:
a communication interface;
a data collection processor configured to respectively collect synthetic data and collected data from a power generation resource unit and a demand resource unit through the communication device; and
a controller configured to generate a digital twin model which learns the collected synthetic data and collected data to predict grid balancing,
the controller further configured to:
correct power grid data based on the open platform, based on an error between the power grid data obtained in the open platform and power grid data obtained in a real time simulator (RTS), and
generate a control signal controlling a power generation resource unit and a demand resource unit by using the corrected power grid data of the open platform and grid balancing data predicted by the digital twin model.

8. The apparatus of claim 7, wherein the controller is further configured to:
generate a physical model which learns the synthetic data to predict the grid balancing data,
generate a data model which learns the collected data to predict the grid balancing data, and
generate a hybrid model which learns the synthetic data, the collected data, the grid balancing data predicted by the physical model, and the grid balancing data predicted by the data model to predict final grid balancing data, and
connect an output of each of the physical model and the data model to an input of the hybrid model to generate the digital twin model, and
the apparatus further comprising a storage configured to store the generated digital twin model.
